(19) United States
(12) Patent Application Publication
(10) Pub. No.: US 2025/0173836 A1
(43) Pub. Date: May 29, 2025

(54) IMAGE PROCESSING DEVICE COMPRISING NEURAL NETWORK MODEL, AND OPERATING METHOD THEREFOR

(71) Applicant: SAMSUNG ELECTRONICS CO., LTD., Suwon-si (KR)

(72) Inventors: Heechul YANG, Suwon-si (KR); Jaehwan KIM, Suwon-si (KR); Pilkyu PARK, Suwon-si (KR); Jungmin LEE, Suwon-si (KR); Jongseok LEE, Suwon-si (KR); Chaeeun LEE, Suwon-si (KR); Youngo Park, Suwon-si (KR); Kwangpyo CHOI, Suwon-si (KR)

(73) Assignee: SAMSUNG ELECTRONICS CO., LTD., Suwon-si (KR)

(21) Appl. No.: 19/040,604

(22) Filed: Jan. 29, 2025

Related U.S. Application Data
(63) Continuation of application No. PCT/KR2023/010040, filed on Jul. 13, 2023.

(30) Foreign Application Priority Data
Sep. 8, 2022 (KR) 10-2022-0114494
Nov. 2, 2022 (KR) 10-2022-0144620

(51) Int. Cl. G06T 5/60; G06T 3/4015; G06T 3/4046

(52) U.S. Cl. CPC G06T 5/60; G06T 3/4015; G06T 3/4046; G06T 2207/10024; G06T 2207/20084

(57) ABSTRACT

An image processing device includes: a memory storing one or more instructions; and at least one processor configured to execute the one or more instructions to: receive additional data to perform an image processing operation for input image data, based on the additional data, determine a number of operations of a neural network model trained to perform the image processing operation on the input image data, and based on the determined number of the operations of the neural network model, use the neural network model to generate output image data by performing the image processing operation on the input image data.

### CROSS-REFERENCE TO RELATED APPLICATIONS

This application is a by-pass continuation application of International Application No. PCT/KR2023/010040, filed on Jul. 13, 2023, which is based on and claims priority to Korean Patent Application Nos. 10-2022-0114494, filed on Sep. 8, 2022, and 10-2022-0144620, filed on Nov. 2, 2022, in the Korean Intellectual Property Office, the disclosures of which are incorporated by reference herein their entireties.

### BACKGROUND

### 1. Field

The disclosure relates to an image processing device including a neural network model and an operating method thereof, and more particularly, to an image processing device, which determines the number of operations of a neural network model for performing an image processing operation and, based on the number of operations, performs the image processing operation, and an operating method of an image processing device.

### 2. Description of Related Art

Recently, with the growing demand for high-quality and high-definition pictures, video, etc., image data generated from an image sensor may be efficiently image-processed by using a neural network model. Based on a neural network, deep learning or machine learning for image processing may be implemented.

In image-processing of image data by using a neural network model, the amount of computation of a neural network processor increases to improve image quality, and this requires a wide area and a lot of resources when implemented in hardware. As the neural network model performs the same image processing operation on all the image data, much time may be required and resources may be wasted. Accordingly, there is a need for technology that adaptively image-processes image data to reduce processing time and resources.

### SUMMARY

According to an embodiment, an image processing device may include a memory for storing one or more instructions and one or more processors for executing the one or more instructions.

The one or more processors may receive additional data to perform an image processing operation for input image data.

The at least one processor may determine a number of operations of a neural network model trained to perform image processing operation on the input image data based on the additional data for performing the image processing operation.

The at least one processor may use the neural network model to generate output image data by performing the image processing operation on the input image data, based on the determined number of operations.

According to an embodiment, a method of operating an image processing device may include receiving additional data to perform an image processing operation for input image data.

In an embodiment, the method of operating the image processing device may include determining a number of operations of a neural network model trained to perform the image processing operation on the input image data based on the additional data for performing the image processing operation.

In an embodiment, the method of operating the image processing device may include using the neural network model, and generating output image data by performing the image processing operation on the input image data based on the number of operations.

Furthermore, the method of operating the electronic device may be provided by being stored on a computer-readable recording medium with a program recorded thereon to be performed by a computer.

According to an aspect of the disclosure, an image processing device includes: a memory storing one or more instructions; and at least one processor configured to execute the one or more instructions to: receive additional data to perform an image processing operation for input image data, based on the additional data, determine a number of operations of a neural network model trained to perform the image processing operation on the input image data, and based on the determined number of the operations of the neural network model, use the neural network model to generate output image data by performing the image processing operation on the input image data.

According to an aspect of the disclosure, an operating method of an image processing device, includes: receiving additional data to perform an image processing operation for input image data; based on the additional data, determining a number of operations of a neural network model trained to perform an image processing operation on the input image data, for performing the image processing operation; and using the neural network model, and, based on the number of operations, generating output image data by performing the image processing operation on the input image data.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device according to an embodiment of the disclosure;

FIG. 2 is a block diagram for describing an image processing device according to an embodiment of the disclosure;

FIG. 3 is a diagram for describing a neural network model according to an embodiment of the disclosure;

FIG. 4 illustrates an example of a neural network structure;

FIGS. 5A to 5C are diagrams for describing operations of a processor, according to an embodiment of the disclosure;

FIG. 6A is a diagram for describing reconstructed image data according to an embodiment of the disclosure;

FIG. 6B is a diagram for describing an occasion when the number of operations for reconstructed image data is one, according to an embodiment of the disclosure;

FIG. 6C is a diagram for describing an occasion when the number of operations for reconstructed image data is two, according to an embodiment of the disclosure;

FIGS. 7A to 7C are diagrams for describing operations of a processor with respect to noise of input image data, according to an embodiment of the disclosure;

FIGS. 8A to 8C are diagrams for describing operations of a processor with respect to patterns of input image data, according to an embodiment of the disclosure;

FIGS. 9A to 9C are diagrams for describing operations of a processor with respect to ISO sensitivity of input image data, according to an embodiment of the disclosure;

FIG. 10 is a diagram for describing operations of a processor with respect to battery information, according to an embodiment of the disclosure;

FIG. 11 is a flowchart for describing an operating method of an image processing device, according to an embodiment of the disclosure; and

FIG. 12 illustrates a detailed configuration of an image processing device, according to an embodiment of the disclosure.

### DETAILED DESCRIPTION

Terms as used herein will be described before describing embodiments of the disclosure in detail.

The terms are selected as common terms currently widely used, taking into account functions in the disclosure, which may however depend on intentions of ordinary people in the art, judicial precedents, emergence of new technologies, and the like. Some terms as herein used are selected at the applicant's discretion, in which case, the meaning will be explained later in detail in the description of the disclosure. Therefore, the terms should be defined based on their meanings and descriptions throughout the disclosure.

As used herein, the singular forms “a”, “an” and “the” are intended to include the plural forms as well, unless the context clearly indicates otherwise. All terms including technical and scientific terms used herein have the same meaning as commonly understood by one of ordinary skill in the art to which this disclosure belongs.

The term “include (or including)” or “comprise (or comprising)” is inclusive or open-ended and does not exclude additional, unrecited elements or method steps. The terms “unit”, “module”, “block”, etc., as used herein each represent a unit for handling at least one function or operation, and may be implemented in hardware, software, or a combination thereof.

Throughout the disclosure, the expression “or” is inclusive rather than exclusive, unless specifically mentioned otherwise. Hence, unless the context clearly indicates otherwise, “A or B” may refer to “A”, “B” or both. Throughout the disclosure, the expression “at least one of” or “one or more” may indicate different combinations of one or more of items enumerated or may refer to an occasion when an arbitrary one of the items enumerated is required. For example, “at least one of A, B, and C” may include any of the following combinations: A, B, C, A and B, A and C, B and C, or A, B and C.

Embodiments of the disclosure will now be described in detail with reference to accompanying drawings to be readily practiced by those of ordinary skill in the art. However, the embodiments of the disclosure may be implemented in many different forms, and are not limited to those discussed herein. In the drawings, parts unrelated to the description are omitted for clarity, and like numerals refer to like elements throughout the specification.

In an embodiment of the disclosure, input image data may refer to image data input to an image processing device, and output image data may refer to image data output from the image processing device.

In an embodiment of the disclosure, additional data is data with which to perform an image processing operation on the input image data, and may include at least one of information about the input image data, information about a user input and information about an apparatus/system where the image processing device is installed.

In an embodiment of the disclosure, a neural network model may refer to an artificial neural network model trained to perform an image processing operation on the input image data.

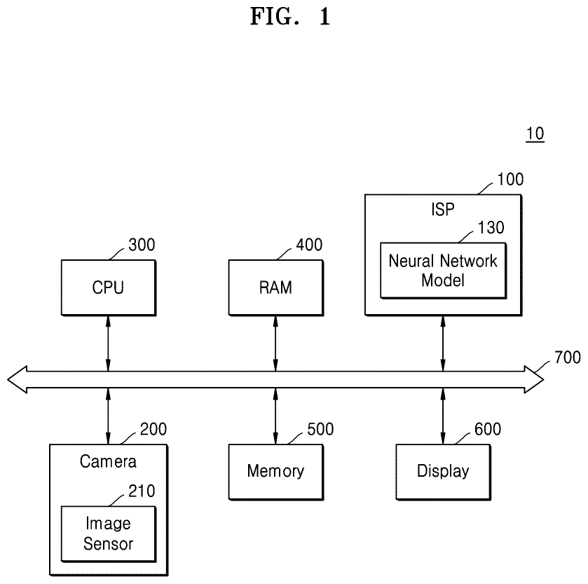

FIG. 1 is a block diagram illustrating an electronic device, according to an embodiment of the disclosure.

In an embodiment of the disclosure, an electronic device 10 may perform an image processing operation on input image data based on a neural network model 130 and generate output image data. The electronic device 10 may include at least one of a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera or a wearable device. In addition, the electronic device 10 may include a smart home appliance. The smart home appliance may include at least one of, for example, a digital video disk (DVD) player, an audio system, an air conditioner, a cleaner, an oven, a microwave, a washing machine, an air purifier, a set-top box, a home automation control panel, a security control panel, a television (TV) box, a game console, an electronic dictionary, an electronic key, a camcorder or an electronic frame. Furthermore, the electronic device may include various medical devices. The medical device may include, for example, various portable medical measuring devices (a blood sugar meter, a heart rate meter, a heart rate monitor, a blood pressure monitor, or a body temperature monitor), magnetic resonance angiography (MRA), magnetic resonance imaging (MRI), computer tomography (CT), a camera or an ultrasonic device. For example, the electronic device 10 may be an application processor. The application processor may perform various types of arithmetic processing. Although not shown in FIG. 1, the electronic device may further include a neural processing unit (NPU) that uses a neural network model 130 to share an arithmetic operation to be processed.

Referring to FIG. 1, the electronic device 10 may include an image processing device 100, a camera 200, a central processing unit (CPU) 300, a random access memory (RAM) 400, a memory 500, a display 600 and a system bus 700. In an embodiment, the electronic device 10 may further include universal components in addition to the components shown in FIG. 1. The components of the electronic device 10 may communicate with each other through the bus 700.

The image processing device 100 may generate output image data by performing image processing on input image data. In an embodiment, the input image data may be image data of a Bayer pattern. The output image data may be linear RGB image data. The image processing device 100 may receive additional data. The additional data may refer to data with which to perform an image processing operation on the input image data. The additional data may include at least one of information about the input image data, information about a user input, and information about an apparatus/system in which the image processing device 100 is installed.

In an embodiment, the apparatus in which the image processing device 100 is installed is the electronic device 10. The image processing device 100 may receive the information about the input image data from the camera 200. The electronic device 10 may further include a user input interface, and the image processing device 100 may receive the information about the user input through the user input interface. The image processing device 100 may receive, from the CPU 300, the information about an apparatus in which the image processing device 100 is installed. It is not, however, limited to the embodiments, and the image processing device 100 may receive the additional data from other components of the electronic device 10 or receive the additional data from outside of the electronic device 10.

The image processing device 100 may determine the number of operations of the neural network model 130 for performing the image processing operation based on the additional data. The image processing device 100 may use the neural network model 130 to perform a neural network operation on the input image data.

In an embodiment of the disclosure, the image processing device 100 may receive image data from the camera 200 or the memory 500, and based on this received image data, perform the neural network operation. The image processing device 100 may perform an image processing operation defined through the neural network operation based on the neural network model 130.

In an embodiment, the neural network model 130 may be trained to perform the image processing operation on the input image data. The image processing operation may include various operations such as a bad pixel correction (BPC) operation, a lens shading correction (LSC) operation, a cross talk (X-talk) correction operation, a remosaic operation, a demosaic operation, a denoise operation, etc. Types of the image processing operation are not limited to the above examples.

The neural network model 130 may be one based on at least one of an artificial neural network (ANN), a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman Machine (RBM), a fully convolutional network, a long short-term memory (LSTM) network, a classification network, a plain residual network, a dense network, a hierarchical pyramid network, or a fully convolutional network. Types of the neural network model are not limited to the above example.

In some embodiments, the neural network model 130 may include a plurality of neural network layers. Each of the plurality of neural network layers has a plurality of weight values and performs neural network calculations through calculations between a calculation result of a previous layer and the plurality of weight values. The plurality of weight values of the plurality of neural network layers may be optimized by a training result of the artificial intelligence model. For example, the plurality of weight values may be updated to minimize a loss value or a cost value, which is obtained from the artificial intelligence model during the process of training. An artificial neural network may include a deep neural network (DNN), and examples of the artificial neural network may include, but are not limited to, a convolutional neural network (CNN), a DNN, a recurrent neural network (RNN), a restricted Boltzmann machine (RBM), a deep belief network (DBN), a bidirectional recurrent deep neural network (BRDNN), and deep Q-Networks.

The image processing device 100 may receive input image data generated from an image sensor 210 of the camera 200, and generate output image data by performing image processing operations on the input image data.

The image processing device 100 may determine the number of operations, and use the neural network model 130 to perform the image processing operation on the input image data according to the determined number of operations. The image processing device 100 may repeatedly perform the image processing operation on the input image data as many times as the number of operations, and generate output image data. The image processing device 100 may perform the image processing operation on the input image data by repeatedly performing the neural network operation with the neural network model 130 as many times as the number of operations. For example, when the number of operations is determined to be two, the image processing device 100 may generate output image data by using the neural network model 130 to perform the image processing operation of the first round on the input image data and using the neural network model 130 again to perform the image processing operation of the second round.

In an embodiment, the image processing device 100 may apply a parameter corresponding to the round in which the neural network model 130 performs the image processing operation to the neural network model 130 based on the number of operations. The parameter is used for the neural network model 130 to perform the neural network operation, and refers to a weight, a bias, etc. The parameter may be stored in an internal memory of the image processing device 100 or in the memory 500. The parameter stored in the memory 500 may be provided to the image processing device 100.

The neural network model 130 may be trained to generate output image data by performing the image processing operation on the input image data. The parameter may be obtained as the neural network model 130 is trained multiple times. The neural network model 130 may be trained based on at least one of the input image data, the additional data, the number of operations and the round, and a parameter corresponding to the number of operations and the round may be obtained. For example, when the number of operations is two, the parameter corresponding to the first round may be a first parameter and the parameter corresponding to the second round may be a second parameter. In another example, when the number of operations is one, the parameter corresponding to the first round may be a third parameter.

A parameter corresponding to a number of operations and a round may be different from the others. When the number of operations is two, the image processing device 100 may apply the first parameter corresponding to the first round to the neural network model 130, and generate first output image data by performing the image processing operation of the first round on the input image data. The image processing device 100 may apply the second parameter corresponding to the second round to the neural network model 130, and generate second output image data by performing the image processing operation of the second round on the input image data. The second output image data may be output as final output image data.

The image processing device 100 may adjust image features to output a final image by adjusting, for the output image data, white balance (WB), adjusting a gamma value, or performing such processing as global tone mapping and local tone mapping. For example, the image processing device 100 may output a sRGB image as the final image of the image processing device 100 by adjusting white balance for the output image data, which is linear RGB image data.

The camera 200 may capture a subject (or object) outside the electronic device 10 and generate image data. For example, the camera 200 may include the image sensor 210. The image sensor 210 may convert an optical signal of the subject to an electrical signal through an optical lens (not shown). For this, the image sensor 210 may include a pixel array where a plurality of pixels are arranged in two dimension (2D). For example, each of the plurality of pixels may be allocated one of a plurality of reference colors. For example, the plurality of reference colors may include red, green and blue (RGB) or red, green blue and white (RGBW).

The camera 200 may generate image data by using the image sensor 210. The image data may be called in many different ways, such as an image frame and frame data. The image data may be provided to the image processing device 100 as the input image data or may be stored in the memory 500. The image data stored in the memory 500 may be provided to the image processing device 100 as the input image data.

The CPU 300 controls general operation of the electronic device 10. The CPU 300 may include one processor core or multiple processor cores (multi-core). The CPU 300 may process or execute programs and/or data stored in a storage section such as the memory 500 by using the RAM 400.

The memory 500 may include at least one of a volatile memory or a nonvolatile memory. The nonvolatile memory includes a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), etc. The volatile memory includes a dynamic RAM (DRAM), a static RAM (SRAM), a synchronous DRAM (SDRAM), a PRAM, an MRAM, an RRAM, a ferroelectric RAM (FeRAM), etc. In an embodiment, the memory 500 may include at least one of a hard disk drive (HDD), a solid state drive (SSD), a compact flash (CF) card, a secure digital (SD) card, a micro SD card, a mini SD card, extreme digital (xD) card or a memory stick.

The display 600 may display various contents (e.g., text, images, video, icons or symbols) for the user based on image data received from the image processing device 100. For example, the display 600 may include a liquid crystal display (LCD), a light emitting diode (LED) display, an organic LED (OLED) display, a microelectromechanical systems (MEMS) display, and an electronic paper display. The display 600 may include a pixel array in which a plurality of pixels are arranged in the form of a matrix to display an image.

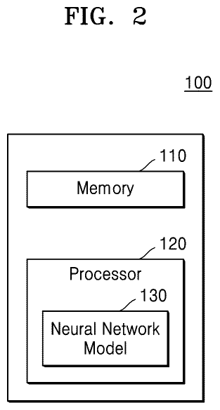

FIG. 2 is a block diagram for describing an image processing device, according to an embodiment of the disclosure. The image processing device 100 and the neural network model 130 in FIG. 2 correspond to the image processing device 100 and the neural network model 130 in FIG. 1, so the overlapping description will not be repeated.

Referring to FIG. 2, the image processing device 100 may include a memory 110 and a processor 120. The processor 120 may correspond to one or more processors or at least one processor because the processor 120 may include other processors, processing units, sub-processors, or co-processors.

The memory 110 may store one or more instructions to be executed by the processor 120. For example, the memory 110 may include instructions for the processor 120 to perform the image processing operation on the input image data. The processor 120 may execute one or more instructions. to receive the additional data. The processor 120 may execute one or more instructions to determine the number of operations of the neural network model 130 for performing the image processing operation based on the additional data. The processor 120 may execute one or more instructions to generate output image data by performing the image processing operation on the input image data based on the number of operations.

The memory 110 is a storage place for storing data, for example, various algorithms, various programs and various data. The memory 110 may store one or more instructions. The memory 110 may include at least one of a volatile memory and a non-volatile memory.-. The nonvolatile memory includes a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), etc. The volatile memory includes a dynamic RAM (DRAM), a static RAM (SRAM), a synchronous DRAM (SDRAM), a PRAM, an MRAM, an RRAM, etc. In an embodiment, the memory 110 may include at least one of a hard disk drive (HDD), a solid state drive (SSD), a compact flash (CF), a secure digital (SD), a micro SD, a mini SD, extreme digital (xD) or a memory stick. In an embodiment, the memory 110 may semi-permanently or temporarily store algorithms, programs and one or more instructions to be executed by the processor 120.

In some embodiments, the processor 120 may control general operation of the image processing device 100. The processor may include one or more processors. Here, the one or more processors may include a general-purpose processor, such as a central processing unit (CPU), an application processor, or a digital signal processor (DSP), a graphics-dedicated processor, such as a graphics processing unit (GPU) or a vision processing unit (VPU), or an artificial intelligence-dedicated processor, such as a neural processing unit (NPU). The one or more processors control input data to be processed according to predefined operation rules or artificial intelligence models, which are stored in the memory. Alternatively, when the one or more processors are artificial intelligence-dedicated processors, the artificial intelligence-dedicated processors may be designed in a hardware structure specialized for processing of a particular artificial intelligence model.

For example, the processor 120 may perform an arithmetic operation or data processing relating to control and/or communication of at least one other component of the image processing device 100.

The processor 120 may execute one or more instructions stored in the memory 110. The processor 120 may execute one or more instructions. to perform the image processing operation. For example, the processor 120 may determine the number of operations of the neural network model 130 for performing the image processing operation based on the additional data. In another example, based on the determined number of operations, the processor 120 may use the neural network model 130 to perform the image processing operation on the input image data to generate output image data.

In an embodiment, the processor 120 may generate output image data by performing image processing on the input image data. The processor 120 may receive additional data. The additional data may refer to data with which to perform an image processing operation on the input image data. The additional data may include at least one of information about the input image data, information about a user input, and information about an apparatus/system in which the image processing device 100 is installed. For example, the processor 120 may receive the additional data including resolution information that is information about the input image data.

The processor 120 may perform a neural network operation based on the received input image data. The processor 120 may use the neural network model 130 to perform the neural network operation. The processor 120 may be implemented with a neural network operation accelerator, a co-processor, a digital signal processor (DSP), an application specific integrated circuit (ASIC), a field programmable gate array (FPGA), a graphics processing unit (GPU), a neural processing unit (NPU), a tensor processing unit (TPU), a multi-processor system-on-chip (MPSoC), etc.

The processor 120 may determine the number of operations of the neural network model 130 for performing the image processing operation based on the additional data. The processor 120 may determine the number of operations of the neural network model 130 for repeating the image processing operation based on the additional data. In an embodiment, the processor 120 may determine the number of operations based on the additional data including the resolution information. For example, the processor 120 may determine the number of operations to be one when the input image data is a 4 K image. The processor 120 may determine the number of operations to be two when the input image data is a full HD (FHD) image.

The processor 120 may use the neural network model 130 to perform the image processing operation on the input image data and generate output image data. The processor 120 may use the neural network model 130 to perform the image processing operation on the input image data based on the determined number of operations. The processor 120 may repeatedly perform the image processing operation on the input image data as many times as the number of operations, and generate output image data. For example, when the number of operations is determined to be two, the processor 120 may generate output image data by using the neural network model 130 to perform the image processing operation of the first round on the input image data and using the neural network model 130 again to perform the image processing operation of the second round.

In an embodiment, the processor 120 may apply a parameter corresponding to the round in which the neural network model 130 performs the image processing operation based on the number of operations to the neural network model 130, and use the neural network model 130 to which the parameter is applied to perform the image processing operation on the input image data. For example, when the number of operations is two, the processor 120 may apply the first parameter corresponding to the first round to the neural network model 130, and generate the first output image data by performing the image processing operation of the first round on the input image data. The processor 120 may apply the second parameter corresponding to the second round to the neural network model 130, and generate the second output image data by performing the image processing operation of the second round on the input image data. The second output image data may be output as final output image data.

In an embodiment, the processor 120 may perform motion correction for the input image data. The motion correction may refer to correcting a motion of the current frame by referring to a motion of an object included in the input image data of the previous frame. Specifically, the processor 120 may obtain a difference between a motion of input image data of the previous frame and a motion of input image data of the current frame based on a motion of an object included in the input image data of the previous frame. The processor 120 may correct the motion of the input image data based on the difference in motion. The processor 120 may generate corrected image data by motion-correcting input image data IIDT.

The processor 120 may use the corrected image data and the neural network model 130 to perform the image processing operation on the input image data. The processor 120 may input the corrected image data and the input image data to the neural network model 130. The processor 120 may determine the number of operations based on the additional data, and use the neural network model 130 to perform the image processing operation on the input image data based on the number of operations and the corrected image data.

The image processing device 100 may determine the number of operations based on the additional data and use the neural network model 130 to perform the image processing operation as many times as the number of operations, thus adjusting image quality and time required for image processing according to the additional data.

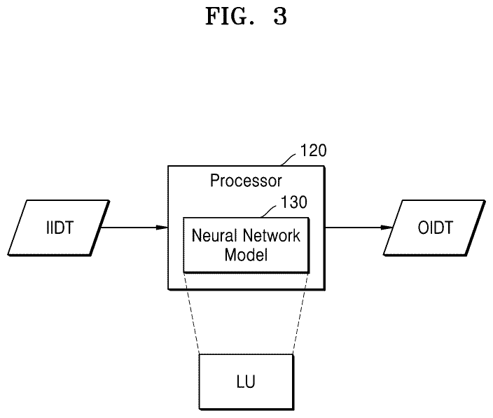

FIG. 3 is a diagram for describing a neural network model, according to an embodiment of the disclosure. The neural network model 130 in FIG. 3 correspond to the neural network model 130 in FIGS. 1 and 2, so the same descriptions about the neural network model will not be repeated.

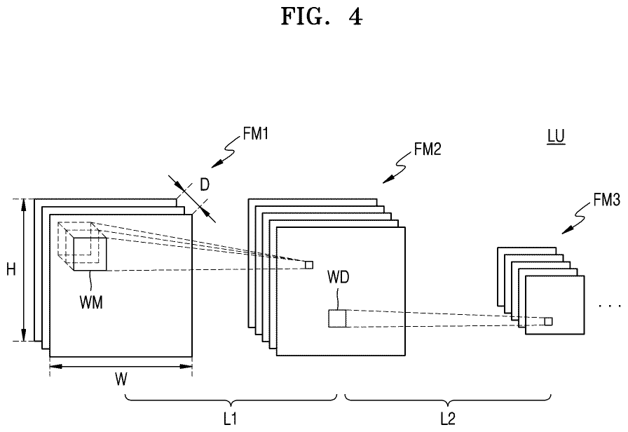

Referring to FIG. 3, the neural network model 130 of FIG. 3 may include a single layer unit LU. The single layer unit may include multiple layers. Each layer may be included to perform an operation (e.g., a convolutional operation) allocated to the layer (e.g., convolutional layer). The neural network model 130 of FIG. 4 may include a single layer unit including a plurality of layers.

The processor 120 may load the neural network model 130, perform an operation for image processing on the input image data IIDT, and generate output image data OIDT according to the operation result.

The neural network model 130 may use image data having a Bayer pattern as the input image data IIDT, and use RGB image data as the output image data OIDT. In an embodiment, the input image data may have a Bayer pattern, and the output image data may be linear RGB image data. The processor 120 may use the neural network model 130 to perform the image processing operation. For example, the processor 120 may use the neural network model 130 to perform an image processing operation that converts the image data of the Bayer pattern into linear RGB image data.

The processor 120 may repeatedly perform the image processing operation as many times as the number of operations on the input image data IIDT by repeating the layer unit LU based on the number of operations as many times as the number of operations. For example, the processor 120 may perform the image processing operation twice on the input image data IIDT by repeating the layer unit LU twice. The processor 120 may perform the image processing operation three times on the input image data IIDT by repeating the layer unit LU three times.

The processor 120 may generate output image data OIDT by performing arithmetic operations included in the layer unit LU on the input image data IIDT based on the number of operations. The processor 120 may generate the output image data OIDT by repeating arithmetic operations included in the layer unit LU as many times as the number of operations on the input image data IIDT. For example, the processor 120 may determine the number of operations to be two, and assume that the layer unit LU includes one convolution layer and one activation layer. The processor 120 may generate the output image data OIDT by performing a first round of convolution operation and activation function operation and performing a second round of convolution operation and activation function operation on the input image data IIDT.

The processor 120 may apply a parameter corresponding to the number of operations and the round of the number of operations to the neural network model 130. Of the number of operations, a round in which the image processing operation is performed first may be referred to as the first round. For example, the number of operations of the neural network model 130 for performing the image processing operation is two, a round in which the image processing operation is performed first may be the first round of the two operations and a round in which the image processing operation is performed later than the first round may be the second round.

The processor 120 may apply a parameter corresponding to the number of operations and the round of the number of operations to the neural network model 130 according to the number of operations and the round. For example, the processor 120 may perform the image processing operation on the input image data IIDT by applying the first parameter corresponding to the first round of the two operations to the neural network model 130. The processor 120 may apply the second parameter corresponding to the second round of the two operations to the neural network model 130 and generate the output image data OIDT by performing the image processing operation on the input image data IIDT.

When a plurality of layer units are included to improve image quality, the input image data IIDT goes through the image processing operation through the plurality of layer units, thereby requiring much time and large amount of calculation. According to an embodiment of the disclosure, a single layer unit LU may be included, thereby saving the amount of calculation and time. As the layer unit UL is repeated according to the number of times, the image processing operation may be adaptively performed on the input image data IIDT.

FIG. 4 illustrates an example of a neural network structure. The neural network structure of FIG. 4 may be applied to the neural network model 130 of FIG. 1. The neural network structure of FIG. 4 may be applied to the layer unit LU of FIG. 3.

Referring to FIG. 4, the layer unit LU may include a plurality of layers L1 to Ln. Each of the plurality of layers L1 to Ln may be a linear layer or non-linear layer, and in an embodiment, at least one linear layer and at least one non-linear layer are combined and referred to as one layer. For example, the linear layer may include a convolution layer or a fully connected layer, and the non-linear layer may include a sampling layer, a pooling layer or an activation layer.

For example, the first layer L1 is the convolution layer and the second layer L2 may be the sampling layer. The layer unit LU may further include the activation layer, and further include a layer that performs a different type of calculation.

Each of the plurality of layers may receive input image data, or a feature map generated from the previous layer as an input feature map, and calculate the input feature map to generate an output feature map. In this case, the feature map refers to data in which various characteristics of the input data is represented. Feature maps FM1, FM2 and FM3 may have the form of e.g., a two dimensional (2D) matrix or a three dimensional (3D) matrix. The feature maps FM1 to FM3 have width W (or columns), height H (or rows) and depth D, which may correspond to the x-axis, the y-axis and the z-axis of the coordinates, respectively. The depth D may be referred to as a number of channels.

The first layer L1 may generate the second feature map FM2 by doing convolution of the first feature map FM1 and a weight map WM. The weight map WM may filer the first feature map FM1, and may be referred to as a filter or a kernel. For example, the depth, i.e., the number of channels, of the weight map WM is equal to the depth, i.e., the number of channels, of the first feature map FM1, and convolution is done for the same channels of the weight map WM and the first feature map FM1.

The weight map WM is shifted in a way of crossing the first feature map FM1 with a sliding window. A shifted amount may be referred to as a stride length or a stride. During each shift, each weight included in the weight map WM may be multiplied by all feature values in the overlapping area of the first feature map FM1 and combined. As the convolution is done for the first feature map FM1 and the weight map WM, a channel of the second feature map FM2 may be generated. Although one weight map WM is shown in FIG. 4, a plurality of weight maps go through convolution with the first feature map FM1 to generate a plurality of channels of the second feature map FM2. In other words, the number of channels of the second feature map FM2 may correspond to the number of weight maps.

The second layer L2 may generate the third feature map FM3 by changing a spatial size of the second feature map FM2. For example, the second layer L2 may be a sampling layer. The second layer L2 may perform up-sampling or down-sampling, and the second layer L2 may select some of the data items included in the second feature map FM2. For example, a 2D window WD may be shifted on the second feature map FM2 by a unit of the size (e.g., a 4*4 matrix) of the window WD, and a value of a certain location (e.g., in the first row and first column) in an area overlapping the window WD may be selected. The second layer L2 may output the selected data as data of the third feature map FM3. In another example, the second layer L2 may be a pooling layer. In this case, the second layer L2 may select a maximum value of feature values (or an average of the feature values) in an area overlapping the window WD in the second feature map FM2. The second layer L2 may output the selected data as data of the third feature map FM3.

Accordingly, the third feature map FM3 may be generated from the second feature map FM2 by changing the spatial size. The channels of the third feature map FM3 and the channels of the second feature map FM2 may be the same in number.

In an embodiment, the second layer L2 is not limited to the sampling layer or the pooling layer. That is, the second layer L2 may be a convolution layer similar to the first layer L1. The second layer L2 may generate the third feature map FM3 by doing convolution of the second feature map FM2 and a weight map. In this case, the weight map that goes through the convolution operation on the second layer L2 may be different from the weight map WM that goes through the convolution operation on the first layer L1.

An N-th feature map may be generated on an N-th layer through a plurality of layers including the first layer L1 and the second layer L2. The N-th feature map may be input to a reconstruction layer located at a back end of the neural network model from which output image data is output. The reconstruction layer may generate the output image data based on the n-th feature map. Furthermore, the reconstruction layer may receive the N-th feature map and a plurality of feature maps such as the first feature map FM1 and the second feature map FM2, and generate the output image data based on the plurality of feature maps. For example, the reconstruction layer may be a convolution layer or a deconvolution layer. In an embodiment, it may be implemented as a different type of layer that may reconstruct an image from the feature map.

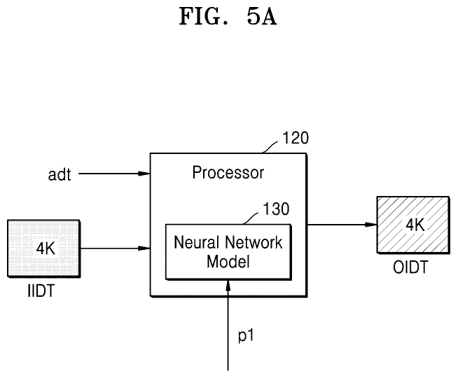

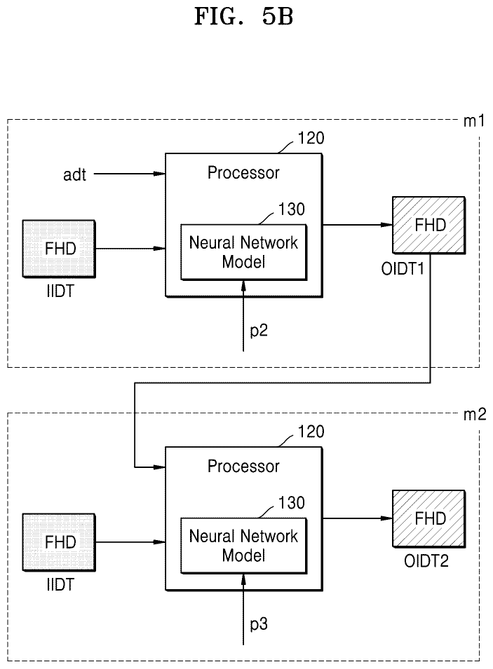

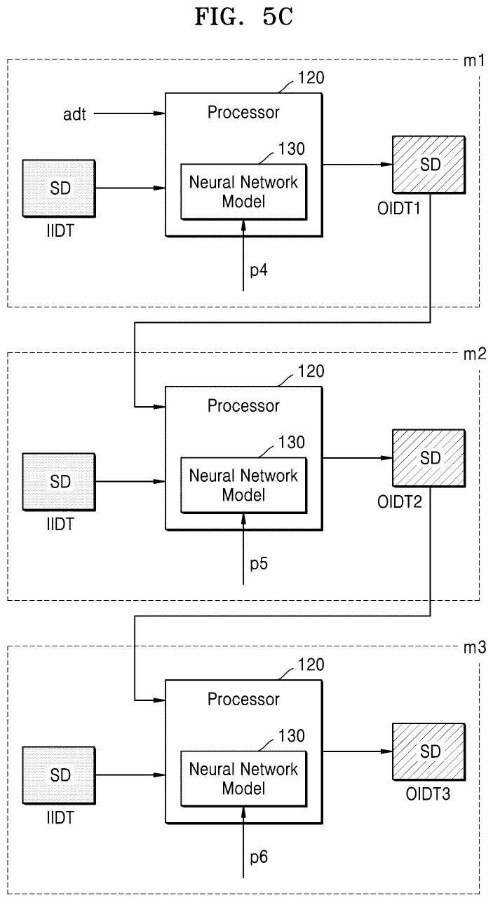

FIGS. 5A to 5C are diagrams for describing operation of a processor, according to an embodiment of the disclosure. FIG. 5A is a diagram for describing an occasion when the number of operations is one, according to an embodiment of the disclosure. Descriptions overlapping with the foregoing will not be repeated.

Referring to FIG. 5A, the processor 120 may receive additional data adt. The processor 120 may determine the number of operations of the neural network model 130 for performing the image processing operation on the input image data IIDT based on the additional data. The additional data may refer to data with which to perform the image processing operation on the input image data IIDT. The additional data may include information about the input image data IIDT, information about a user input, and information about an apparatus/system in which the image processing device is installed.

In an embodiment, the additional data adt may include resolution information relating to the input image data IIDT. For example, the additional data adt may include resolution information indicating that the input image data IIDT has a 4K resolution. The processor 120 may determine the number of operations based on the resolution information relating to the input image data IIDT. For example, when the input image data IIDT has the 4K resolution, the processor 120 may determine the number of operations to be one.

The processor 120 may apply a parameter corresponding to the round in which the neural network model 130 performs the image processing operation based on the number of operations to the neural network model 130. For example, the processor 120 may apply a first parameter p1 corresponding to a first round of the one operation to the neural network model 130. The processor 120 may use the neural network model 130, to which the first parameter p1 is applied, to perform the image processing operation of the first round on the input image data IIDT, and generate the output image data OIDT.

FIG. 5B is a diagram for describing an occasion when the number of operations is two, according to an embodiment of the disclosure. Although the processor 120 and the neural network model 130 are illustrated as if being two each, this describes that the image processing operation is repeatedly performed twice, and the processor 120 and the neural network model 130, which are one each, may be used to perform the image processing operation. Descriptions overlapping with the foregoing will not be repeated.

The additional data adt may include resolution information relating to the input image data IIDT. For example, the additional data adt may include resolution information indicating that the input image data IIDT has a full high definition (FHD) resolution. The processor 120 may determine the number of operations based on the resolution information relating to the input image data IIDT. For example, when the input image data IIDT has the FHD resolution, the processor 120 may determine the number of operations to be two.

In an embodiment, the processor 120 may determine the number of operations when the resolution information is a second resolution to be larger than when the resolution information is a first resolution. The second resolution may be lower than the first resolution. For example, the first resolution may be the 4 K resolution, and the second resolution may be the FHD resolution. The processor 120 may determine the number of operations to be one when the resolution of the input image data IIDT is 4 K, and the number of operations to be two when the resolution of the input image data IIDT is FHD. The processor 120 may adjust the time and amount of calculation required for image processing by determining the number of operations based on the additional data and performing the image processing operation according to the number of operations.

The processor 120 may use the neural network model 130 to perform the image processing operation of a first round m1 on the input image data IIDT, and repeat the neural network model 130 one more time to perform the image processing operation of a second round m2 on the input image data IIDT. The more times the image processing operation on the input image data IIDT is repeated, the better the image quality may become.

The processor 120 may apply a parameter corresponding to the round in which the neural network model 130 performs the image processing operation based on the number of operations to the neural network model 130. For example, the processor 120 may apply a second parameter p2 corresponding to the first round m1 of the two operations to the neural network model 130. The processor 120 may use the neural network model 130, to which the second parameter p2 is applied, to perform the image processing operation of the first round m1 on the input image data IIDT, and generate first output image data OIDT1.

In an embodiment, the processor 120 may change the parameter applied to the neural network model 130. When the number of operations is N (N is a positive number equal to or greater than 2) and the round is m (m is a positive number equal to or less than N−1), the processor 120 may apply a parameter corresponding to the round m to the neural network model 130 to perform the image processing operation of round m, and change the parameter corresponding to the round m to a parameter corresponding to a round (m+1). For example, the processor 120 may apply the second parameter p2 to perform the image processing operation of the first round m1, and change the second parameter p2 to the third parameter p3. The third parameter p3 may correspond to the second round m2 of the two operations. The processor 120 may apply the second parameter p2 to the neural network model 130 to generate the first output image data OIDT1, and apply the third parameter p3 to the neural network model 130.

When the number of operations is N (N is a positive number equal to or greater than 2) and the round is m (m is a positive number equal to or less than N−1), the processor 120 may input the input image data IIDT and an output of the neural network model 130 of the round m to the neural network model 130 of the round (m+1). An output of the previous round and the input image data IIDT may be input to the next round. The processor 120 may perform the image processing operation of the first round m1, and then, perform the image processing operation of the second round m2. The processor 120 may input the input image data IIDT and the first output image data OIDT1, an output of the first round m1 to the neural network model 130 to perform the image processing operation of the second round m2.

The processor 120 may use the neural network model 130, to which the third parameter p3 is applied, to perform the image processing operation of the second round m2 on the input image data IIDT, and generate second output image data OIDT2. The processor 120 may output the second output image data OIDT2 as final output image data of the neural network model 130. The second output image data OIDT2 may have more improved quality than the first output image data OIDT1.

FIG. 5C is a diagram for describing an occasion when the number of operations is three, according to an embodiment of the disclosure. Descriptions overlapping with what are described in FIGS. 5A and 5B will not be repeated.

The additional data adt may include resolution information relating to the input image data IIDT. For example, the additional data adt may include resolution information indicating that the input image data IIDT has a standard definition (SD) resolution. The processor 120 may determine the number of operations based on the resolution information relating to the input image data IIDT. For example, when the input image data IIDT has the SD resolution, the processor 120 may determine the number of operations to be three.

In an embodiment, the processor 120 may determine the number of operations when the resolution information is a second resolution to be larger than when the resolution information is a first resolution. The second resolution may be lower than the first resolution. For example, the first resolution may be the 4 K resolution, and the second resolution may be the SD resolution. The processor 120 may determine the number of operations to be one when the resolution of the input image data IIDT is 4 K, and the number of operations to be three when the resolution of the input image data IIDT is SD.

The processor 120 may use the neural network model 130 to perform the image processing operation of a first round m1 on the input image data IIDT, repeat the neural network model 130 to perform the image processing operation of the second round m2 on the input image data IIDT, and repeat the neural network model 130 one more time to perform the image processing operation of a third round m3 on the input image data IIDT. The more times the image processing operation on the input image data IIDT is repeated, the better the image quality may become.

The processor 120 may apply a fourth parameter p4 corresponding to the first round m1 of the three operations to the neural network model 130. The processor 120 may use the neural network model 130, to which the fourth parameter p4 is applied, to perform the image processing operation of the first round m1 on the input image data IIDT, and generate the first output image data OIDT1.

The processor 120 may apply the fourth parameter p4 to perform the image processing operation of the first round m1, and change the fourth parameter p4 to a fifth parameter p5. The fifth parameter p5 may correspond to the second round m2 of the three operations. The processor 120 may apply the fourth parameter p4 to the neural network model 130 to generate the first output image data OIDT1, and apply the fifth parameter p5 to the neural network model 130.

The processor 120 may perform the image processing operation of the first round m1, and then, perform the image processing operation of the second round m2. The processor 120 may input the input image data IIDT and the first output image data OIDT1 to the neural network model 130 to perform the image processing operation of the second round m2. The processor 120 may use the neural network model 130, to which the fifth parameter p5 is applied, to perform the image processing operation of the second round m2 on the input image data IIDT, and generate the second output image data OIDT2. The second output image data OIDT2 may have more improved quality than the first output image data OIDT1.

The processor 120 may apply the fifth parameter p5 to perform the image processing operation of the second round m2, and change the fifth parameter p5 to a sixth parameter p6. The sixth parameter p6 may correspond to the third round m3 of the three operations. The processor 120 may apply the fifth parameter p5 to the neural network model 130 to generate the second output image data OIDT2, and apply the sixth parameter p6 to the neural network model 130.

The processor 120 may perform the image processing operation of the first round m1 and then perform the image processing operation of the second round m2. The processor 120 may perform the image processing operation of the second round m2 and then perform the image processing operation of the third round m3. The processor 120 may input the input image data IIDT and the second output image data OIDT2, an output of the second round m2 to the neural network model 130 to perform the image processing operation of the third round m3. The processor 120 may use the neural network model 130, to which the sixth parameter p6 is applied, to perform the image processing operation of the third round m3 on the input image data IIDT, and generate the third output image data OIDT3. The processor 120 may output the third output image data OIDT3 as final output image data of the neural network model 130. The third output image data OIDT3 may have more improved quality than the second output image data OIDT2.

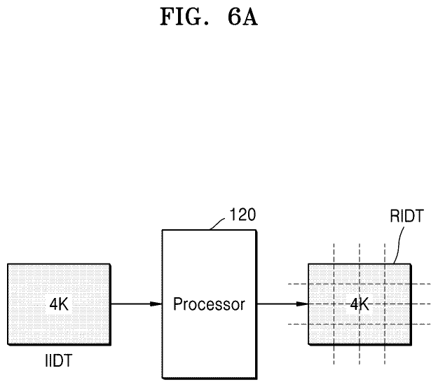

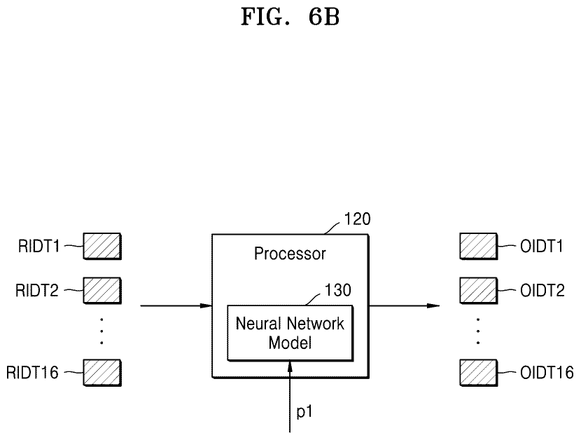

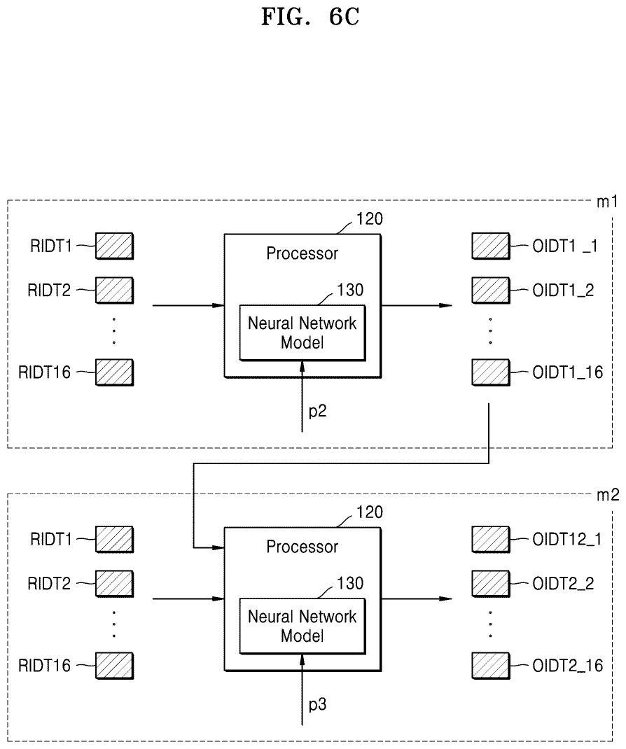

FIG. 6A is a diagram for describing reconstructed image data, according to an embodiment of the disclosure. Descriptions overlapping with the foregoing will not be repeated.

Referring to FIG. 6A, the processor 120 may receive input image data IIDT. In an embodiment, the processor 120 may generate reconstructed image data RIDT by dividing the input image data IIDT. The processor 120 may generate the reconstructed image data RIDT having a smaller unit than the size of the input image data IIDT.

The processor 120 may generate a plurality of reconstructed image data items RIDTs by dividing the input image data IIDT. For example, the processor 120 may generate sixteen reconstructed image data items RIDTs from the input image data IIDT.

FIG. 6B is a diagram for describing an occasion when the number of operations for reconstructed image data is one, according to an embodiment of the disclosure. Descriptions overlapping with the foregoing will not be repeated.

Referring to FIGS. 6A and 6B, the processor 120 may determine the number of operations for the input image data IIDT based on the additional data. The processor 120 may use the neural network model 130 to repeatedly perform the image processing operation on each of the reconstructed image data items RIDT1 to RIDT16 as many times as the number of operations.

The processor 120 may apply the first parameter p1 corresponding to the first round of the number of operations to the neural network model 130. The processor 120 may use the neural network model 130, to which the first parameter p1 is applied, to perform the image processing operation of the first round on each of the reconstructed image data items RIDT1 to RIDT16, and generate output image data OIDT1 to OIDT16.

The processor 120 may perform the image processing operation on each of the reconstructed image data items RIDT1 to RIDT16, and generate output image data OIDT1 to OIDT16. For example, the processor 120 may perform the image processing operation of the first round on the first reconstructed image data RIDT1, and generate the output image data OIDT1. The processor 120 may perform the image processing operation of the first round on the second reconstructed image data RIDT2, and generate the output image data OIDT2. The processor 120 may perform the image processing operation of the first round on the sixteenth reconstructed image data RIDT16, and generate the output image data OIDT16. The processor 120 may perform a total of 16 image processing operations.

In an embodiment, the processor 120 may merge the output image data items OIDT1 to OIDT16 and output the merged output image data OIDT1 to OIDT16 as final output image data of the neural network model 130. It is not, however, limited thereto, and the output image data OIDT1 to OIDT16 may be merged outside the processor 120.

FIG. 6C is a diagram for describing an occasion when the number of operations for reconstructed image data is two, according to an embodiment of the disclosure. Descriptions overlapping with what are described in FIGS. 6A and 6B will not be repeated.

Referring to FIGS. 6A and 6C, the processor 120 may determine the number of operations of the neural network model 130 for performing the image processing operation on the input image data IIDT based on the additional data. The processor 120 may use the neural network model 130 to repeatedly perform the image processing operation on each of the reconstructed image data items RIDT1 to RIDT16 as many times as the number of operations.

The processor 120 may apply the second parameter p2 corresponding to the first round m1 of the two operations to the neural network model 130. The processor 120 may use the neural network model 130, to which the second parameter p2 is applied, to perform the image processing operation of the first round m1 on each of the reconstructed image data items RIDT1 to RIDT16, and generate first output image data OIDT1_1 to OIDT1_16. For example, the processor 120 may perform the image processing operation of the first round m1 on the first reconstructed image data RIDT1, and generate the first output image data OIDT1_1. The processor 120 may perform the image processing operation of the first round m1 on the second reconstructed image data RIDT2, and generate the first output image data OIDT1_2. The processor 120 may perform the image processing operation of the first round m1 on the sixteenth reconstructed image data RIDT16, and generate the first output image data OIDT1_16.

In an embodiment, the processor 120 may change the parameter applied to the neural network model 130. The processor 120 may apply the second parameter p2 to perform the image processing operation of the first round m1, and change the second parameter p2 to the third parameter p3. The third parameter p3 may correspond to the second round m2 of the two operations. The processor 120 may apply the second parameter p2 to the neural network model 130 to generate the first output image data OIDT1_1 to OIDT1_16, and apply the third parameter p3 to the neural network model 130.

The processor 120 may perform the image processing operation of the first round m1 and then perform the image processing operation of the second round m2. The processor 120 may input the reconstructed image data RIDT1 to RIDT 16 and the first output image data OIDT1_1 to OIDT1_16, outputs of the first round m1 to the neural network model 130 to perform the image processing operation of the second round m2.

The processor 120 may use the neural network model 130, to which the third parameter p3 is applied, to perform the image processing operation of the second round m2 on each of the reconstructed image data items RIDT1 to RIDT16, and generate second output image data OIDT2_1 to OIDT2_16. For example, the processor 120 may perform the image processing operation of the first round m1 on the first reconstructed image data RIDT1, and generate the second output image data OIDT2_1. The processor 120 may perform the image processing operation of the second round m2 on the second reconstructed image data RIDT2, and generate the second output image data OIDT2_2. The processor 120 may perform the image processing operation of the second round m2 on the sixteenth reconstructed image data RIDT16, and generate the second output image data OIDT2_16.

The processor 120 may perform a total of 32 image processing operations. The processor 120 may merge the second output image data items OIDT2_1 to OIDT2_16 and output the merged output image data OIDT2_1 to OIDT2_16 as final output image data of the neural network model 130. It is not, however, limited thereto, and the output image data items OIDT1 to OIDT16 may be merged outside the processor 120.

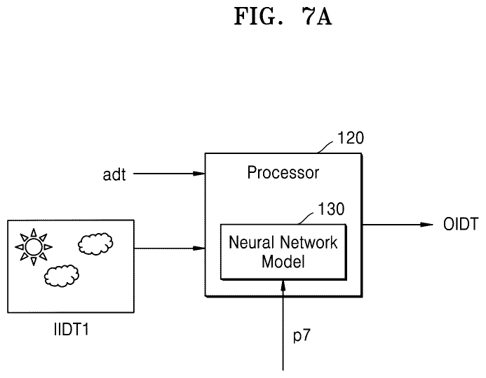

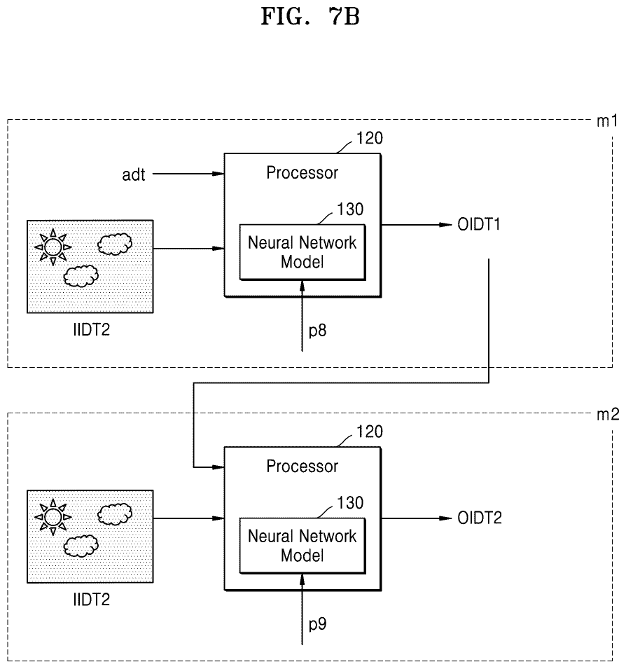

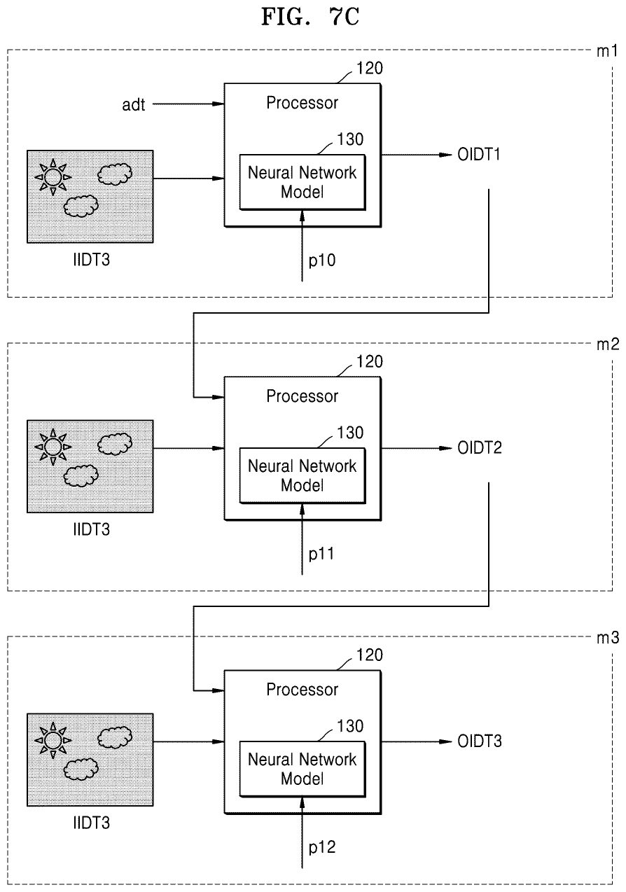

FIGS. 7A to 7C are diagrams for describing operation of a processor for input image data with noise, according to an embodiment of the disclosure. FIG. 7A describes an occasion when the number of operations is determined to be one based on noise information of input image data, according to an embodiment of the disclosure. Descriptions overlapping with the foregoing will not be repeated.

Referring to FIG. 7A, the processor 120 may receive additional data adt. The processor 120 may determine the number of operations of the neural network model 130 for the first input image data IIDT1 based on the additional data adt.

In an embodiment, the additional data adt may include noise information relating to the first input image data IIDT1. The noise information may refer to a degree of noise included in the first input image data IIDT1. For example, when the input image data is an image captured in daylight, it contains little noise, and when the input image data is an image captured at night, it contains a lot of noise.

The degree of noise may be expected in various methods. For example, the degree of noise may be expected based on a difference between values of flat portions rather than corners or edges of the image data of a difference between original image data and image data blurred by e.g., Gaussian blurring on the input image data. Furthermore, the degree of noise may be expected using the variance of the original image data and the blurred image data. In another example, it may be expected based on a difference between the original image and an average of several temporal image data items by aligning the several temporal image data items.

The processor 120 may determine the number of operations based on the noise information relating to the first input image data IIDT1. The first input image data IIDT1 is an image with little noise, which may be captured in daylight. For example, the processor 120 may determine the number of operations to be one for the first input image data IIDT1. When the input image data has little noise, image quality may not be lowered even when the image processing operation is performed one time. The processor 120 may adjust time and amount of calculation required for image processing depending on the degree of noise of the input image data IIDT by determining the number of operations according to the noise information of the input image data IIDT.

The processor 120 may apply a parameter corresponding to the round in which the neural network model 130 performs the image processing operation based on the number of operations to the neural network model 130. For example, the processor 120 may apply a seventh parameter p7 corresponding to the first round of the one operation on the first input image data IIDT1 to the neural network model 130. The processor 120 may use the neural network model 130, to which the seventh parameter p7 is applied, to perform the image processing operation of the first round on the first input image data IIDT1, and generate the output image data OIDT.

FIG. 7B is a diagram for describing an occasion when the number of operations is determined to be two based on noise information of input image data, according to an embodiment of the disclosure. Descriptions overlapping with the foregoing will not be repeated. In the following description, reference is made to FIG. 7B with FIG. 7A.

The additional data adt may include noise information relating to second input image data IIDT2. The processor 120 may determine the number of operations based on the noise information relating to the second input image data IIDT2. The second image data IIDT2 may be an image with more noise than the first input image data IIDT1, which may be captured indoors.

In an embodiment, the processor 120 may determine the number of operations for the second input image data IIDT2 to be larger than the number of operations for the first input image data IIDT1. The second image data IIDT2 may have more noise than the first input image data IIDT1. For example, the processor 120 may determine the number of operations to be two for the second input image data IIDT2. As the second input image data IIDT2 has more noise than the first input image data IIDT1, the image processing operation may be performed more times than the number of operations for the first input image data IIDT1, and thus, the image quality may be improved.

The processor 120 may use the neural network model 130 to perform the image processing operation of the first round m1 on the second input image data IIDT2, and repeat the neural network model 130 one more time to perform the image processing operation of the second round m2 on the second input image data IIDT2. The more times the image processing operation is repeated on the second input image data IIDT2, the better the image quality may become.

The processor 120 may apply an eighth parameter p8 corresponding to the first round m1 of two operations on the second input image data IIDT2 to the neural network model 130. The processor 120 may use the neural network model 130, to which the eighth parameter p8 is applied, to perform the image processing operation of the first round m1 on the second input image data IIDT2, and generate the first output image data OIDT1.

The processor 120 may change the eighth parameter p8 to a ninth parameter p9. The ninth parameter p9 may correspond to the second round m2 of the two operations for the second input image data IIDT2. The processor 120 may apply the eighth parameter p8 to the neural network model 130 to generate the first output image data OIDT1, and apply the ninth parameter p9 to the neural network model 130.

The processor 120 may perform the image processing operation of the first round m1 and then perform the image processing operation of the second round m2. The processor 120 may input the second input image data IIDT2 and the first output image data OIDT1 to the neural network model 130 to perform the image processing operation of the second round m2.

The processor 120 may use the neural network model 130, to which the ninth parameter p9 is applied, to perform the image processing operation of the second round m2 on the second input image data IIDT2, and generate the second output image data OIDT2. The processor 120 may output the second output image data OIDT2 as final output image data of the neural network model 130. The second image data OIDT2 may have more improved quality than the first output image data OIDT1.

FIG. 7C is a diagram for describing an occasion when the number of operations is determined to be three based on noise information of input image data, according to an embodiment of the disclosure. Descriptions overlapping with the foregoing will not be repeated. In the following description, reference is made to FIG. 7C with FIG. 7B.

The additional data adt may include noise information relating to third input image data IIDT3. The processor 120 may determine the number of operations based on the noise information relating to the third input image data IIDT3. The third output image data IIDT3 may be an image with more noise than the second input image data IIDT2, which may be captured at night.

The third output image data IIDT3 may have more noise than the second input image data IIDT2. For example, the processor 120 may determine the number of operations to be three for the third input image data IIDT3. As the third input image data IIDT3 has more noise than the second input image data IIDT2, the image processing operation may be performed more times than the number of operations for the second input image data IIDT2, and thus, the image quality may be improved.

The processor 120 may apply a tenth parameter p10 corresponding to the first round m1 of three operations on the third input image data IIDT3 to the neural network model 130. The processor 120 may use the neural network model 130, to which the tenth parameter p10 is applied, to perform the image processing operation of the first round m1 on the third input image data IIDT3, and generate the first output image data OIDT1.

The processor 120 may apply the tenth parameter p10 to perform the image processing operation of the first round m1, and change the tenth parameter p10 to an eleventh parameter p11. The eleventh parameter p11 may correspond to the second round m2 of the three operations for the third input image data IIDT3. The processor 120 may apply the eleventh parameter p11 to the neural network model 130.

The processor 120 may perform the image processing operation of the first round m1 and then perform the image processing operation of the second round m2. The processor 120 may input the third input image data IIDT3 and the first output image data OIDT1, an output of the first round m1 to the neural network model 130 to perform the image processing operation of the second round m2.

The processor 120 may use the neural network model 130, to which the eleventh parameter p11 is applied, to perform the image processing operation of the second round m2 on the third input image data IIDT3, and generate the second output image data OIDT2. The second output image data OIDT2 may have more improved quality than the first output image data OIDT1.

The processor 120 may apply the eleventh parameter p11 to perform the image processing operation of the second round m2, and change the eleventh parameter p11 to a twelfth parameter p12. The twelfth parameter p12 may correspond to a third round m3 of the three operations for the third input image data IIDT3. The processor 120 may apply the twelfth parameter p12 to the neural network model 130.

The processor 120 may input the third input image data IIDT3 and the second output image data OIDT2, an output of the second round m2 to the neural network model 130 to perform the image processing operation of the third round m3. The processor 120 may use the neural network model 130, to which the twelfth parameter p12 is applied, to perform the image processing operation of the third round m3 on the third input image data IIDT3, and generate the third output image data OIDT3. The processor 120 may output the third output image data OIDT3 as final output image data. The third output image data OIDT3 may have more improved quality than the second output image data OIDT2.

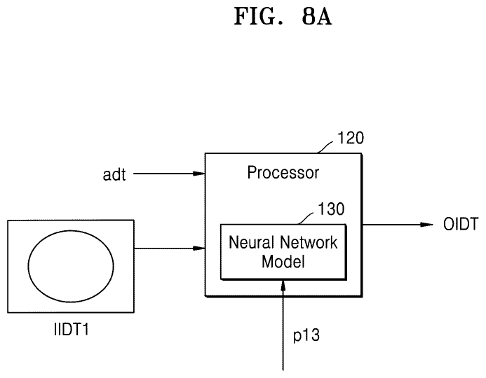

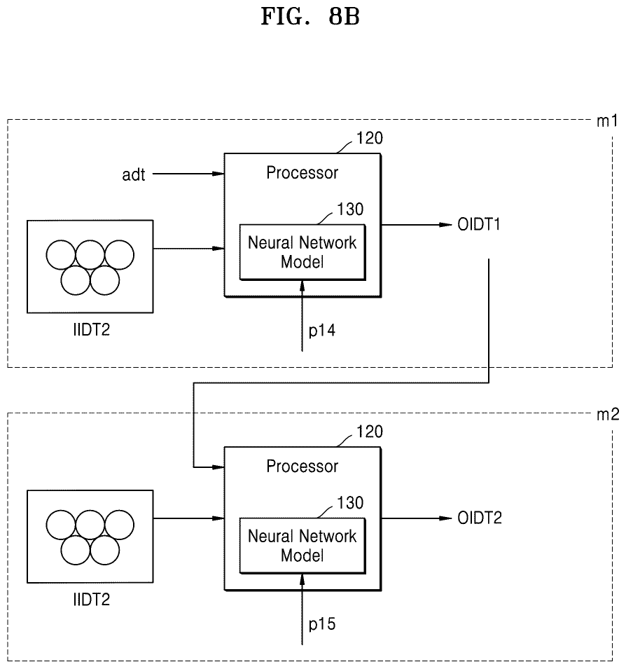

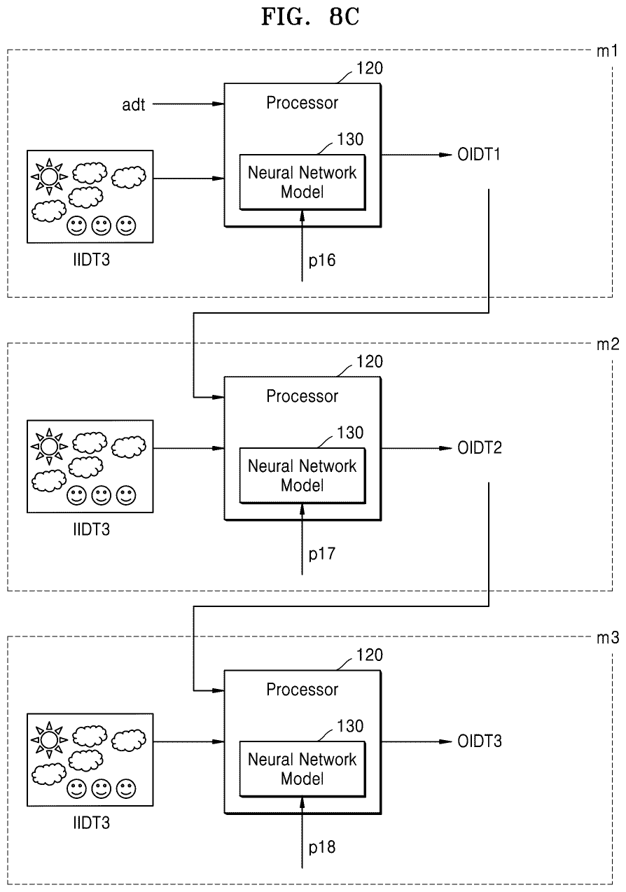

FIGS. 8A to 8C are diagrams for describing operation of a processor with respect to patterns of input image data, according to an embodiment of the disclosure. FIG. 8A is a diagram for describing an occasion when the number of operations is determined to be one based on pattern information of input image data, according to an embodiment of the disclosure. Descriptions overlapping with the foregoing will not be repeated.

Referring to FIG. 8A, the processor 120 may receive additional data adt. The processor 120 may determine the number of operations of the neural network model 130 for performing the image processing operation on the first input image data IIDT1 based on the additional data adt.

In an embodiment, the additional data adt may include pattern information relating to the first input image data IIDT1. The pattern information may indicate a degree of complexity of patterns included in the input image data. The degree of complexity may refer to complexity. The complexity may be obtained based on various methods. The complexity may be obtained based on the variance and standard deviation of the whole image or a block area obtained by block processing of the image. Furthermore, the complexity may be obtained by performing discrete Fourier transform, discrete cosine transform, etc., on the whole image or the block area, and extracting energy from the transformed area. The complexity may be obtained based on edges and/or the number of corners of the transformed area and a ratio of the edges and/or corners in the transformed area.

The processor 120 may determine the number of operations based on the pattern information relating to the first input image data IIDT1. The first input image data IIDT1 may be an image having a simple pattern. For example, the processor 120 may determine the number of operations to be one for the first input image data IIDT1. The processor 120 may adjust time and amount of calculation required for image processing depending on the degree of complexity of the pattern of the input image data IIDT by determining the number of operations according to the pattern information of the input image data IIDT.

The processor 120 may apply a thirteenth parameter p13 corresponding to the first round of one operation on the first input image data IIDT1 to the neural network model 130. The processor 120 may use the neural network model 130, to which the thirteenth parameter p13 is applied, to perform the image processing operation of the first round on the first input image data IIDT1, and generate the output image data OIDT.

FIG. 8B is a diagram for describing an occasion when the number of operations is determined to be two based on pattern information of input image data, according to an embodiment of the disclosure. Descriptions overlapping with the foregoing will not be repeated. In the following description, reference is made to FIG. 8B with FIG. 8A.

The additional data adt may include pattern information relating to second input image data IIDT2. The processor 120 may determine the number of operations based on the pattern information relating to the second input image data IIDT2. The second input image data IIDT2 may be an image having a more complicated pattern than the first input image data IIDT1. For example, the second input image data IIDT2 may have more pixels that include corners, edges and lines than the first input image data IIDT1.

In an embodiment, the processor 120 may determine the number of operations for the second input image data IIDT2 to be larger than the number of operations for the first input image data IIDT1. For example, the processor 120 may determine the number of operations to be two for the second input image data IIDT2.

The processor 120 may use the neural network model 130 to perform the image processing operation of the first round m1 on the second input image data IIDT2, and repeat the neural network model 130 one more time to perform the image processing operation of the second round m2 on the second input image data IIDT2. The more times the image processing operation is repeated on the second input image data IIDT2, the better the image quality may become.

The processor 120 may apply a fourteenth parameter p14 corresponding to the first round m1 of two operations on the second input image data IIDT2 to the neural network model 130. The processor 120 may use the neural network model 130, to which the fourteenth parameter p14 is applied, to perform the image processing operation of the first round m1 on the second input image data IIDT2, and generate the first output image data OIDT1.

The processor 120 may apply the fourteenth parameter p14 to perform the image processing operation of the first round m1, and change the fourteenth parameter p14 to a fifteenth parameter p15. The fifteenth parameter p15 may correspond to the second round m2 of the two operations for the second input image data IIDT2.

The processor 120 may input the second input image data IIDT2 and the first output image data OIDT1, an output of the first round m1 to the neural network model 130 to perform the image processing operation of the second round m2. The processor 120 may use the neural network model 130, to which the fifteenth parameter p15 is applied, to perform the image processing operation of the second round m2 on the second input image data IIDT2, and generate the second output image data OIDT2. The processor 120 may output the second output image data OIDT2 as final output image data of the neural network model 130.

FIG. 8C is a diagram for describing an occasion when the number of operations is determined to be three based on pattern information of input image data, according to an embodiment of the disclosure. Descriptions overlapping with the foregoing will not be repeated. In the following description, reference is made to FIG. 8C with FIG. 8B.

The additional data adt may include pattern information relating to third input image data IIDT3. The processor 120 may determine the number of operations based on the pattern information relating to the third input image data IIDT3. The third input image data IIDT3 may be an image having a more complicated pattern than the second input image data IIDT2. For example, the third input image data IIDT3 may have more pixels that include corners, edges and lines than the second input image data IIDT2.

For example, the processor 120 may determine the number of operations to be three for the third input image data IIDT3. The processor 120 may apply a sixteenth parameter p16 corresponding to the first round m1 of three operations on the third input image data IIDT3 to the neural network model 130. The processor 120 may use the neural network model 130, to which the sixteenth parameter p16 is applied, to perform the image processing operation of the first round m1 on the third input image data IIDT3, and generate the first output image data OIDT1.

The processor 120 may apply the sixteenth parameter p16 to perform the image processing operation of the first round m1, and change the sixteenth parameter p16 to a seventeenth parameter p17. The seventeenth parameter p17 may correspond to the second round m2 of the three operations for the third input image data IIDT3. The processor 120 may input the third input image data IIDT3 and the first output image data OIDT1, an output of the first round m1 to the neural network model 130 to perform the image processing operation of the second round m2.

The processor 120 may use the neural network model 130, to which the eleventh parameter p11 is applied, to perform the image processing operation of the second round m2 on the third input image data IIDT3, and generate the second output image data OIDT2. The second output image data OIDT2 may have more improved quality than the first output image data OIDT1.

The processor 120 may apply the seventeenth parameter p17 to perform the image processing operation of the second round m2, and change the seventeenth parameter p17 to an eighteenth parameter p18. The eighteenth parameter p18 may correspond to a third round m3 of the three operations for the third input image data IIDT3. The processor 120 may apply the eighteenth parameter p18 to the neural network model 130.

The processor 120 may input the third input image data IIDT3 and the second output image data OIDT2, an output of the second round m2 to the neural network model 130 to perform the image processing operation of the third round m3. The processor 120 may use the neural network model 130, to which the eighteenth parameter p18 is applied, to perform the image processing operation of the third round m3 on the third input image data IIDT3, and generate the third output image data OIDT3. The processor 120 may output the third output image data OIDT3 as final output image data. The third output image data OIDT3 may have more improved quality than the second output image data OIDT2.

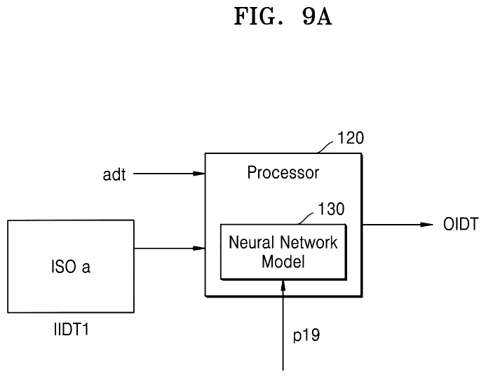

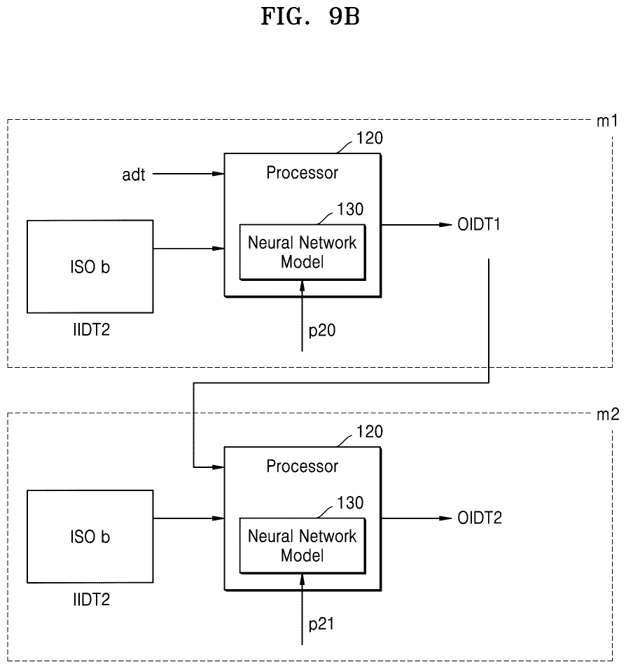

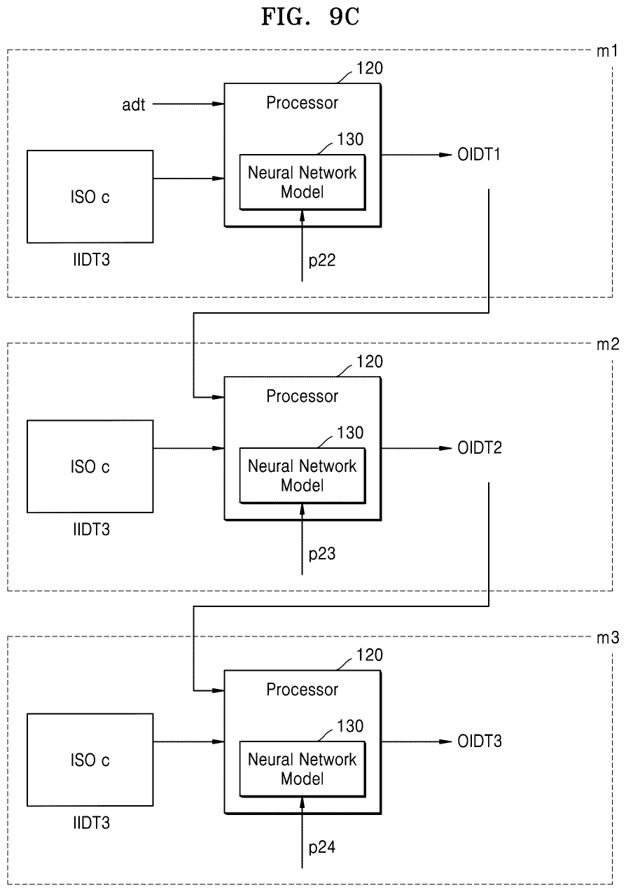

FIGS. 9A to 9C are diagrams for describing operation of a processor with respect to ISO sensitivity of input image data, according to an embodiment of the disclosure. FIG. 9A is a diagram for describing an occasion when the number of operations is determined to be one based on ISO information of input image data, according to an embodiment of the disclosure. Descriptions overlapping with the foregoing will not be repeated.

Referring to FIG. 9A, the processor 120 may receive additional data adt. The processor 120 may determine the number of operations of the neural network model 130 for performing the image processing operation on the first input image data IIDT1 based on the additional data adt.

In an embodiment, the additional data adt may include international organization of standardization (ISO) information relating to the first input image data IIDT1. The ISO information may refer to information about film speed of a camera. The processor 120 may determine the number of operations based on the ISO information relating to the first input image data IIDT1.

When the ISO sensitivity belongs to a first range, the processor 120 may determine the number of operations to be one; when the ISO sensitivity belongs to a second range, the processor 120 may determine the number of operations to be two; when the ISO sensitivity belongs to a third range, the processor 120 may determine the number of operations to be three. For example, when the ISO sensitivity is equal to or greater than zero (0) and less than 100, the processor 120 may determine the number of operations to be one; when the ISO sensitivity is equal to or greater than 100 and less than 400, the processor 120 may determine the number of operations to be two; when the ISO sensitivity is equal to or greater than 400 and less than 6400, the processor 120 may determine the number of operations to be three. The number of operations was described as one, two or three throughout the specification, it is not limited thereto and the number of operations may be many different ones.

The first input image data IIDT1 may be input image data having ISO sensitivity of ‘a’. The ISO sensitivity of the first input image data IIDT1 may belong to the first range. For example, the processor 120 may determine the number of operations to be one for the first input image data IIDT1. The processor 120 may adjust time and amount of calculation required for image processing depending on the ISO sensitivity of the input image data IIDT by determining the number of operations according to the ISO information of the input image data.

The processor 120 may apply a nineteenth parameter p19 corresponding to the first round of one operation on the first input image data IIDT1 to the neural network model 130. The processor 120 may use the neural network model 130, to which the nineteenth parameter p19 is applied, to perform the image processing operation of the first round on the first input image data IIDT1, and generate the output image data OIDT.

FIG. 9B is a diagram for describing an occasion when the number of operations is determined to be two based on ISO information of input image data, according to an embodiment of the disclosure. Descriptions overlapping with the foregoing will not be repeated. In the following description, reference is made to FIG. 9B with FIG. 9A.

The additional data adt may include ISO information relating to second input image data IIDT2. The processor 120 may determine the number of operations based on the ISO information relating to the second input image data IIDT2. The second input image data IIDT2 may be input image data having ISO sensitivity of ‘b’. The ISO sensitivity of the second input image data IIDT2 may belong to the second range. For example, the processor 120 may determine the number of operations to be two for the second input image data IIDT2.

The processor 120 may apply a twentieth parameter p20 corresponding to the first round m1 of two operations on the second input image data IIDT2 to the neural network model 130. The processor 120 may use the neural network model 130, to which the twentieth parameter p20 is applied, to perform the image processing operation of the first round m1 on the second input image data IIDT2, and generate the first output image data OIDT1.

The processor 120 may change the twentieth parameter p20 to a twenty-first parameter p21. The twenty-first parameter p21 may correspond to the second round m2 of the two operations for the second input image data IIDT2.

The processor 120 may input the second input image data IIDT2 and the first output image data OIDT1, an output of the first round m1 to the neural network model 130 to perform the image processing operation of the second round m2. The processor 120 may use the neural network model 130, to which the twenty-first parameter p21 is applied, to perform the image processing operation of the second round m2 on the second input image data IIDT2, and generate the second output image data OIDT2. The processor 120 may output the second output image data OIDT2 as final output image data.

FIG. 9C is a diagram for describing an occasion when the number of operations is determined to be three based on ISO information of input image data, according to an embodiment of the disclosure. Descriptions overlapping with the foregoing will not be repeated. In the following description, reference is made to FIG. 9C with FIG. 9B.

The additional data adt may include ISO information relating to the third input image data IIDT3. The processor 120 may determine the number of operations based on the ISO information relating to the third input image data IIDT3. The third input image data IIDT3 may be input image data having ISO sensitivity of ‘c’. The ISO sensitivity of the third input image data IIDT3 may belong to the third range. For example, the processor 120 may determine the number of operations to be three for the third input image data IIDT3.

The processor 120 may apply a twenty-second parameter p22 corresponding to the first round m1 of three operations on the third input image data IIDT3 to the neural network model 130. The processor 120 may use the neural network model 130, to which the twenty-second parameter p22 is applied, to perform the image processing operation of the first round m1 on the third input image data IIDT3, and generate the first output image data OIDT1.

The processor 120 may change the twenty-second parameter p22 to a twenty-third parameter p23. The twenty-third parameter p23 may correspond to the second round m2 of the three operations for the third input image data IIDT3. The processor 120 may input the third input image data IIDT3 and the first output image data OIDT1, an output of the first round m1 to the neural network model 130 to perform the image processing operation of the second round m2.

The processor 120 may use the neural network model 130, to which the twenty-third parameter p23 is applied, to perform the image processing operation of the second round m2 on the third input image data IIDT3, and generate the second output image data OIDT2.

The processor 120 may change the twenty-third parameter p23 to a twenty-fourth parameter p24. The twenty-fourth parameter p24 may correspond to the third round m3 of the three operations for the third input image data IIDT3. The processor 120 may apply the twenty-fourth parameter p24 to the neural network model 130.

The processor 120 may input the third input image data IIDT3 and the second output image data OIDT2, an output of the second round m2 to the neural network model 130 to perform the image processing operation of the third round m3. The processor 120 may use the neural network model 130, to which the twenty-fourth parameter p24 is applied, to perform the image processing operation of the third round m3 on the third input image data IIDT3, and generate the third output image data OIDT3. The processor 120 may output the third output image data OIDT3 as final output image data.

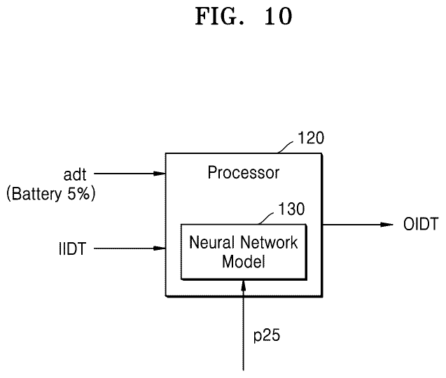

FIG. 10 is a diagram for describing operation of a processor with respect to battery information, according to an embodiment of the disclosure. Descriptions overlapping with the foregoing will not be repeated.

Referring to FIG. 10, the processor 120 may receive additional data adt. The processor 120 may determine the number of operations of the neural network model 130 for performing the image processing operation on the input image data IIDT based on the additional data. The additional data may include information about the first input image data IIDT1, information about a user input, and information about an apparatus/system in which the image processing device (e.g., the image processing device 100 of FIG. 1) is installed.

In an embodiment, the additional data adt may include battery information relating to the apparatus/system in which the image processing device is installed. For example, the additional data adt may include battery information relating to an electronic device (e.g., the electronic device 10 of FIG. 1) in which the image processing device is installed. The battery information may indicate a battery level of the electronic device. The processor 120 may determine the number of operations based on the battery information.

For example, when the battery level belongs to a first range, the processor 120 may determine the number of operations to be one; when the battery level belongs to a second range, the processor 120 may determine the number of operations to be two; when the battery level belongs to a third range, the processor 120 may determine the number of operations to be three. For example, when the battery level is equal to or greater than 0% and less than 15%, the processor 120 may determine the number of operations to be one; when the battery level is equal to or greater than 15% and less than 60%, the processor 120 may determine the number of operations to be two; when the battery level is equal to or greater than 60% and less than 100%, the processor 120 may determine the number of operations to be three. It is not, however, limited thereto, and the number of operations may be three or more and a different number of image processing operations may be performed according to the battery level.

For example, the additional data adt may include battery information indicating a battery level of 5%. The processor 120 may determine the number of operations to be one for the first input image data IIDT1 based on the battery information. The processor 120 may adjust time and amount of calculation required for processing by determining the number of operations based on information about the apparatus in which the image processing device is installed.

The processor 120 may apply a twenty-fifth parameter p25 corresponding to the first round of one operation on the input image data IIDT to the neural network model 130. The processor 120 may use the neural network model 130, to which the twenty-fifth parameter p25 is applied, to perform the image processing operation of the first round on the input image data IIDT, and generate the output image data OIDT.

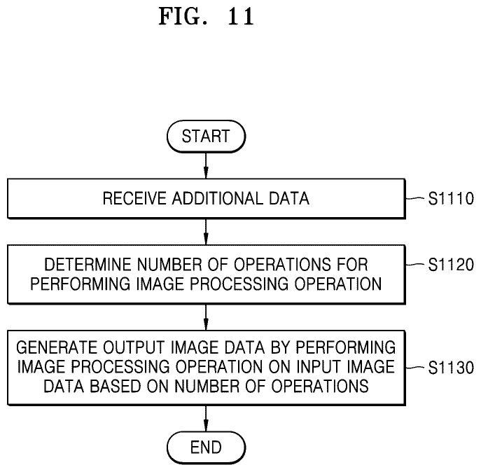

FIG. 11 is a flowchart for describing a method of operating an image processing device, according to an embodiment of the disclosure. Specifically, FIG. 11 shows a method of operating the image processing device 100 of FIG. 1.

In operation S1110, the image processing device may receive additional data that may refer to data with which to perform an image processing operation on the input image data. The additional data may include at least one of information about the input image data, information about a user input, and information about an apparatus/system in which the image processing device is installed.

In an embodiment, the apparatus in which the image processing device is installed may be an electronic device (e.g., the electronic device 10 of FIG. 1). For example, the additional data may include resolution information, noise information, pattern information and ISO information for the input image data, battery information of the electronic device in which the image processing device is installed, etc.

In operation S1120, the image processing device may determine the number of operations of the neural network model for performing the image processing operation based on the additional data. The neural network model may be trained to perform the image processing operation on the input image data. In an embodiment, the image processing device may determine the number of operations based on the resolution information of the input image data. For example, the image processing device may determine the number of operations to be one when the input image data has a 4 K resolution, and determine the number of operations to be two when the input image data has an FHD resolution.

In an embodiment, the image processing device may determine the number of operations based on the battery information of the electronic device. For example, the image processing device may determine the number of operations to be one when the battery level of the electronic device is 5%. The image processing device may determine the number of operations to be three when the battery level of the electronic device is 90%.

In operation S1130, the image processing device may generate output image data by performing the image processing operation on the input image data based on the number of operations. The image processing device may repeatedly perform the image processing operation on the neural network model as many times as the number of operations for the input image data. The image processing device may perform the image processing operation on the input image data by repeatedly performing a neural network operation on the neural network model as many times as the number of operations. For example, when the number of operations is determined to be two, the image processing device may generate output image data by using the neural network model to perform the image processing operation of a first round on the input image data and using the neural network model again to perform the image processing operation of the second round.

In an embodiment, the image processing device may apply a parameter corresponding to a round in which the neural network model performs the image processing operation based on the number of operations to the neural network model 130. The parameter is used to perform a neural network operation of the neural network model, and may refer to a weight, a bias, etc. For example, when the number of operations is two, the image processing device may apply the first parameter corresponding to the first round of the two operations to the neural network, and generate first output image data by performing the image processing operation of the first round on the input image data. The image processing device may apply the second parameter corresponding to the second round of the two operations to the neural network model, and generate second output image data by performing the image processing operation of the second round on the input image data. The second output image data may be output as final output image data.

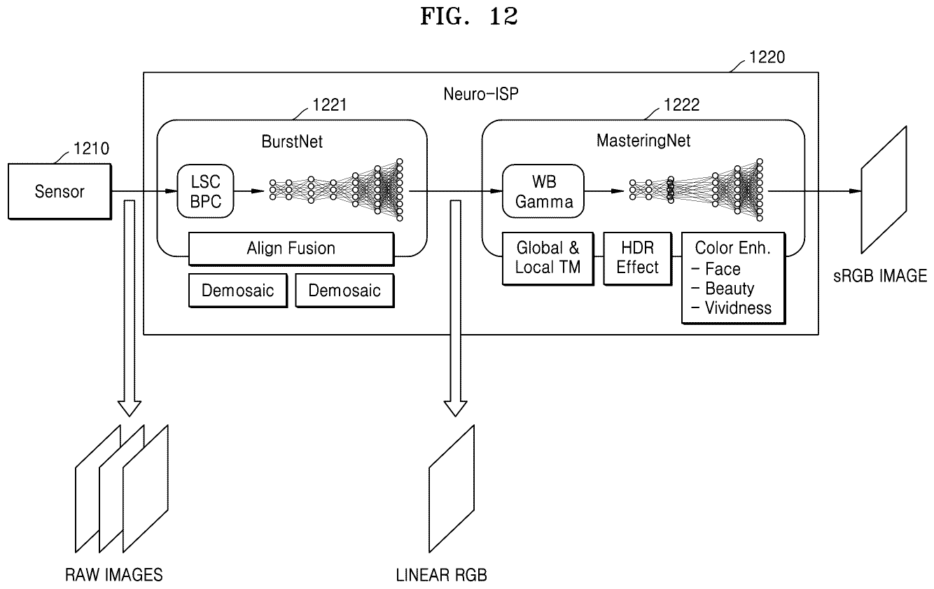

FIG. 12 schematically illustrates a detailed configuration of an image processing device, according to an embodiment of the disclosure. A sensor 1210 of FIG. 12 may correspond to the image sensor 210 of FIG. 1. A neuro-ISP 1220 of FIG. 12 corresponds to a detailed example of the image processing device 100 of FIG. 11.

Referring to FIG. 12, the sensor 1210 may output a plurality of primitive images. In this case, the primitive image is an image output from an image sensor of a camera, which may refer to an image of a Bayer format having only one color channel for each pixel. The plurality of primitive images may correspond to the input image data to the neural network model 130 of FIG. 1.

A BurstNet 1221 of FIG. 12 may correspond to the neural network model 130 of FIG. 1. The BurstNet 1221 may receive an input of the plurality of primitive images and output one linear RGB image data. The plurality of primitive images input to the BurstNet 1221 are a plurality of images captured before or after a certain time, and the BurstNet 1221 may output one linear RGB image by using temporal information of the primitive images and performing demosaicing and denoising. The output linear RGB image may correspond to output image data of the neural network model in the embodiments of the disclosure.

The linear RGB image data may be input to a mastering net 1222. The mastering net 1222 may perform correction on the linear RGB image data. The mastering net 1222 may be a neural network model that performs correction by adjusting an image feature for the linear RGB image data. For example, the mastering net 1222 may adjust image features to output a sRGB image as a final image by adjusting, for the linear RGB image, white balance (WB), adjusting a gamma value, or performing such processing as global tone mapping and local tone mapping.

According to an embodiment, an image processing device may include a memory for storing one or more instructions and one or more processors for executing the one or more instructions.

The one or more processors may receive additional data to perform an image processing operation on input image data.

The at least one processor may determine a number of operations of the neural network model 130 trained to perform an image processing operation on the input image data based on the additional data for performing the image processing operation.

The at least one processor may generate output image data by performing the image processing operation on the input image data by using the neural network model, based on the determined number of operations.

The neural network model may include a layer unit including a plurality of layers.

The at least one processor may repeat the layer unit as many times as the number of operations to repeatedly perform the image processing operation as many times as the number of operations on the input image data, and generate the output image data.

The at least one processor may apply a parameter corresponding to a round in which the neural network model 130 performs the image processing operation based on the number of operations to the neural network model, and generate the output image data by performing the image processing operation on the input image data.

When the number of operations is N (N is a positive number equal to or greater than 2) and the round is m (m is a positive number equal to or less than N−1), the one or more processors may input the input image data and an output of the neural network model of the round m to the neural network model of a round (m+1).

The one or more processors may perform an image processing operation of the round m by applying a parameter corresponding to the round m to the neural network model, and change the parameter corresponding to the round m to a parameter corresponding to the round (m+1).

The neural network model may use image data having a Bayer pattern as input image data, and use RGB image data as output image data.

The additional data may include resolution information of the input image data.

The one or more processors may determine the number of operations based on the resolution information.

The one or more processors may determine the number of operations when the resolution information is a first resolution to be larger than when the resolution information is a second resolution which is lower than the first resolution.

The one or more processors may generate, from the input image data, reconstructed image data items having a smaller unit than a size of the input image data, use the neural network model to repeatedly perform the image processing operation as many times as the number of operations on each of the reconstructed image data items, and generate output image data.

The one or more processors may generate corrected image data by performing motion correction on the input image data, and use the corrected image data and the neural network model to perform the image processing operation on the input image data to generate the output image data.

According to an embodiment, a method of operating an image processing device may include receiving additional data to perform an image processing operation on input image data.

In an embodiment, the method of operating the image processing device may include determining a number of operations of a neural network model trained to perform an image processing operation on the input image data based on the additional data for performing the image processing operation.

In an embodiment, the method of operating the image processing device may include generating output image data by using the neural network model and performing the image processing operation on the input image data based on the number of operations.

In an embodiment, the neural network model may include a layer unit including a plurality of layers, and the generating of the output image data may include repeatedly performing the image processing operation as many times as the number of operations on the input image data by repeating the layer unit as many times as the number of operations.

In an embodiment, the generating of the output image data may include applying a parameter corresponding to a round in which the neural network model performs the image processing operation based on the number of operations to the neural network model.

In an embodiment, when the number of operations is N (N is a positive number equal to or greater than 2) and the round is m (m is a positive number equal to or less than N−1), the generating of the output image data may include inputting the input image data and an output of the neural network model of the round m to the neural network model of a round (m+1).

In an embodiment, the applying of the parameter corresponding to the round to the neural network model 130 may include performing the image processing operation of the round m by applying a parameter corresponding to the round m to the neural network model 130.

In an embodiment, the applying of the parameter corresponding to the round to the neural network model 130 may include changing the parameter corresponding to the round m to a parameter corresponding to a round (m+1).

In an embodiment, the additional data may include resolution information of the input image data, and the determining of the number of operations may include determining the number of operations based on the resolution information.

In an embodiment, the determining of the number of operations may include determining the number of operations when the resolution information is a first resolution to be larger than when the resolution information is a second resolution which is lower than the first resolution.

In an embodiment, the determining of the number of operations may include generating from the input image data reconstructed image data items having a smaller unit than a size of the input image data.

In an embodiment, the generating of the output image data may include generating the output image data by using the neural network model 130 to repeatedly perform the image processing operation as many times as the number of operations on each of the reconstructed image data items.

In an embodiment, the method of operating the image processing may further include generating corrected image data by performing motion correction on the input image data.

In an embodiment, the generating of the output image data may include generating the output image data by using the corrected image data and the neural network model to perform the image processing operation on the input image data.

Furthermore, the method of operating the electronic device may be provided by being stored on a computer-readable recording medium with a program recorded thereon to be performed by a computer.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

According to an embodiment, the aforementioned method according to the various embodiments of the disclosure may be provided in a computer program product. The computer program product may be a commercial product that may be traded between a seller and a buyer. The computer program product may be distributed in the form of a machine-readable storage medium (e.g., a CD-ROM) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

What is claimed is:

1. An image processing device comprising:
a memory storing one or more instructions; and
at least one processor configured to execute the one or more instructions to:
receive additional data to perform an image processing operation for input image data,
based on the additional data, determine a number of operations of a neural network model trained to perform the image processing operation on the input image data, and
based on the determined number of the operations of the neural network model, use the neural network model to generate output image data by performing the image processing operation on the input image data.

2. The image processing device of claim 1, wherein the neural network model comprises a layer unit including a plurality of layers, and
wherein the at least one processor is further configured to, by repeating the layer unit same time as the number of operations to repeatedly perform the image processing operation same time as the number of operations performed on the input image data, generate the output image data.

3. The image processing device of claim 1, wherein the at least one processor is further configured to:
apply to the neural network model a parameter corresponding to a round in which the neural network model performs the image processing operation, based on the number of operations, and
generate the output image data by performing the image processing operation on the input image data.

4. The image processing device of claim 3, wherein the at least one processor is further configured to, when the number of operations is N, where N is a first positive number of 2 or more, and the round is m, where m is a second positive number equal to or less than (N−1), input the input image data and an output of the neural network model of the round m to the neural network model of a round (m+1).

5. The image processing device of claim 4, wherein the at least one processor is further configured to:
perform the image processing operation of the round m by applying a parameter corresponding to the round m to the neural network model, and
change the parameter corresponding to the round m to a parameter corresponding to the round (m+1).

6. The image processing device of claim 1, wherein the neural network model is configured to:
use image data having a Bayer pattern as input image data, and
use RGB image data as the output image data.

7. The image processing device of claim 1, wherein the additional data comprises resolution information of the input image data, and
wherein the at least one processor is further configured to determine the number of operations, based on the resolution information.

8. The image processing device of claim 7, wherein the at least one processor is further configured to determine the number of operations when the resolution information corresponds to a first resolution, to be larger than when the resolution information corresponds to a second resolution which is lower than the first resolution.

9. The image processing device of claim 1, wherein the at least one processor is further configured to:
generate, from the input image data, reconstructed image data items having a smaller unit than a size of the input image data, and
use the neural network model to repeatedly perform, on each of the reconstructed image data items, the image processing operation same time as the number of operations, and generate the output image data.

10. The image processing device of claim 1, wherein the at least one processor is further configured to:
generate corrected image data by performing motion correction on the input image data, and
use the corrected image data and the neural network model to generate the output image data by performing the image processing operation on the input image data.

11. An operating method of an image processing device, the operating method comprising:
receiving additional data to perform an image processing operation for input image data;
based on the additional data, determining a number of operations of a neural network model trained to perform an image processing operation on the input image data, for performing the image processing operation; and
using the neural network model, and, based on the number of operations, generating output image data by performing the image processing operation on the input image data.

12. The operating method of claim 11, wherein the neural network model comprises a layer unit including a plurality of layers, and
wherein the generating of the output image data comprises repeating the layer unit same time as the number of operations to repeatedly perform, on the input image data, the image processing operation same time as the number of operations.

13. The operating method of claim 11, wherein the generating of the output image data comprises applying a parameter corresponding to a round in which the neural network model performs the image processing operation, based on the number of operations, to the neural network model.

14. The operating method of claim 11, wherein the determining of the number of operations comprises determining the number of operations when resolution information corresponds to a first resolution, to be larger than when the resolution information corresponds to a second resolution which is lower than the first resolution.

15. The operating method of claim 11, wherein the determining of the number of operations comprises generating, from the input image data, reconstructed image data items having a smaller unit than a size of the input image data, and
wherein the generating of the output image data comprises, by using the neural network model to repeatedly perform, on each of the reconstructed image data items, the image processing operation same time as the number of operations, generating the output image data.
